(19) United States
(12) Patent Application Publication
(10) Pub. No.: US 2007/0171849 A1
(43) Pub. Date: Jul. 26, 2007

(54) SCHEDULING CHANNEL QUALITY INDICATOR AND ACKNOWLEDGEMENT/NEGATIVE ACKNOWLEDGEMENT FEEDBACK

(75) Inventors: Guodong Zhang, Farmingdale, NY (US); Jung-Lin Pan, Selden, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/616,504

(22) Filed: Dec. 27, 2006

Related U.S. Application Data
(60) Provisional application No. 60/756,035, filed on Jan. 3, 2006.

(51) Int. Cl. H04B 7/00

(52) U.S. Cl. 370/310; 455/69

(57) ABSTRACT

A method for transmitting feedback by a user equipment in a wireless communication system includes scheduling a non-contention based uplink channel; and transmitting the feedback on the scheduled uplink channel. The feedback can include a channel quality indicator and an acknowledgement/negative acknowledgement for received downlink data. The feedback can be multiplexed is various ways for efficient transmission.

### CROSS REFERENCE TO RELATED APPLICATION

This application claims the benefit of U.S. Provisional Application No. 60/756,035, filed on Jan. 3, 2006, which is incorporated by reference as if fully set forth herein.

### FIELD OF INVENTION

The invention relates to wireless communication systems, in particular to scheduling and multiplexing of channel quality indicator (CQI) and acknowledgement/negative acknowledgement (ACK/NACK) feedback in uplink (UL) single carrier frequency division multiple access (SC-FDMA) for evolved universal terrestrial radio access (E-UTRA).

### BACKGROUND

Both 3GPP and 3GPP2 are currently considering long term evolution projects, in which evolution of the radio interface and the network architecture are necessary. SC-FDMA has been adopted for the uplink of E-UTRA, and orthogonal frequency division multiple access (OFDMA) has been adopted for the downlink.

Downlink CQI measured by a user equipment (UE) is used by the Node B for scheduling the downlink shared data channel. After decoding the downlink data transmission, the UE needs to send feedback (e.g., an ACK/NACK) to the Node B to inform the Node B whether the corresponding HARQ transmission is successful. Uplink transport format information and HARQ information are called uplink data-associated control information. On the other hand, CQI and ACK/NACK for downlink data transmissions are called uplink data-non-associated control information. One problem that needs to be addressed in the E-UTRA system is how to schedule the reporting of the downlink CQI and the ACK/NACK via a UL channel. For convenience, the UL channel that transmits the CQI is called UL CQICH, and the UL channel that transmits the ACK/NACK is called UL ACKCH.

In the prior art of High Speed Downlink Packet Access (HSDPA), a dedicated low data rate channel is allocated for the UE to report the CQI together with the ACK/NACK to the Node B, and the dedicated channel is exclusive for the UE all the time. However, using a dedicated channel to transmit the CQI and the ACK/NACK limits the number of UEs that can be simultaneously supported.

### SUMMARY

A method for transmitting feedback by a UE in a wireless communication system includes scheduling a non-contention based UL channel; and transmitting the feedback on the scheduled UL channel. The feedback can include a channel quality indicator and an ACK/NACK for received downlink data. The feedback can be multiplexed is various ways for efficient transmission.

The scheduling procedures can also include scheduling periodic feedback reporting, determining a location of the UL channel to use for the feedback reporting, and signaling the location of the UL channel and the feedback reporting period to the UE.

The selection of the multiplexing scheme is based on at least one of: whether downlink data was transmitted to a UE in the preceding sub-frame, whether UL data was transmitted to the UE in the current sub-frame, and whether the CQI bits are configured to be transmitted in the current sub-frame. Various multiplexing schemes are disclosed based on combinations of the foregoing determinations. Among those schemes, there can be several options per scheme, with the option being selected by the implementer.

A system for scheduling and multiplexing feedback reporting in a wireless communication system includes a user equipment (UE) and a Node B. The UE includes a first processor; a first transmitter/receiver in communication with the first processor; a first antenna connected to the first transmitter/receiver; a feedback generator in communication with the first processor and the first multiplexer, the feedback generator for generating feedback based on received downlink data; and a first multiplexer in communication with the first processor, the first multiplexer for multiplexing feedback information from the feedback generator with other uplink data. The Node B includes a second processor; a buffer in communication with the second processor, the buffer storing data to be sent to the UE; a second transmitter/receiver in communication with the second processor; a second antenna connected to the second transmitter/receiver; a second multiplexer in communication with the second processor; a scheduler in communication with the second processor and the second transmitter/receiver, the scheduler for scheduling an uplink feedback channel; and a mapping device in communication with the scheduler, the mapping device for mapping resource blocks from a downlink communication to an uplink feedback channel location.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a flowchart of a method for scheduling CQI reporting;

FIG. 2 is a flowchart of a method for scheduling ACK/NACK reporting;

FIG. 3 is a flowchart of a method for multiplexing when the CQI feedback is sent every sub-frame;

FIG. 4 is a flowchart of a method for multiplexing when the CQI feedback is sent less frequently than every sub-frame; and

FIG. 5 is a block diagram of a system for scheduling and multiplexing CQI reporting and ACK/NACK reporting.

### DETAILED DESCRIPTION OF THE PREFERRED EMBODIMENTS

Hereafter, the term “user equipment (UE)” includes, but is not limited to, a wireless transmit/receive unit (WTRU), a mobile station, a fixed or mobile subscriber unit, a pager, cellular telephone, personal digital assistant (PDA), computer, or any other type of device capable of operating in a wireless environment. When referred to hereafter, the term “base station (BS)” includes, but is not limited to, a Node B, a site controller, an access point, or any other type of interfacing device in a wireless environment.

Scheduling of the UL CQICH

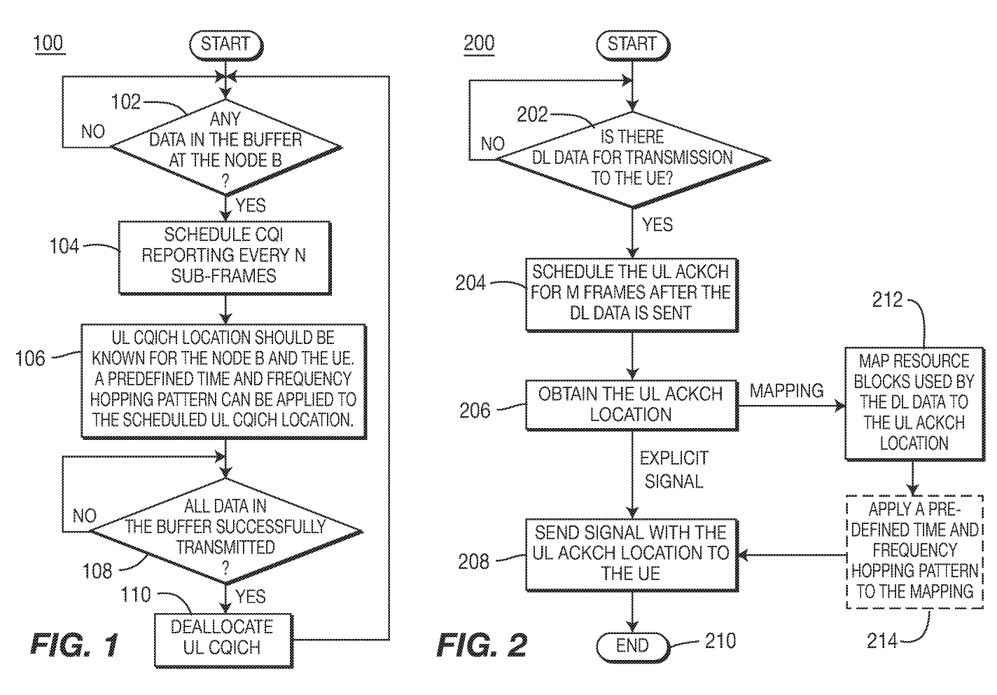

The present invention uses a shared channel to transmit CQI in uplink SC-FDMA in a non-contention-based manner. A method 100 for scheduling the CQICH is shown in FIG. 1. First, a determination is made whether there is any data for a UE in the buffer at the Node B (step 102). If there is no data in the buffer, then the method waits at step 102 until there is data in the buffer. When there is no data for a UE in the buffer at the Node B, no uplink CQICH needs to be scheduled.

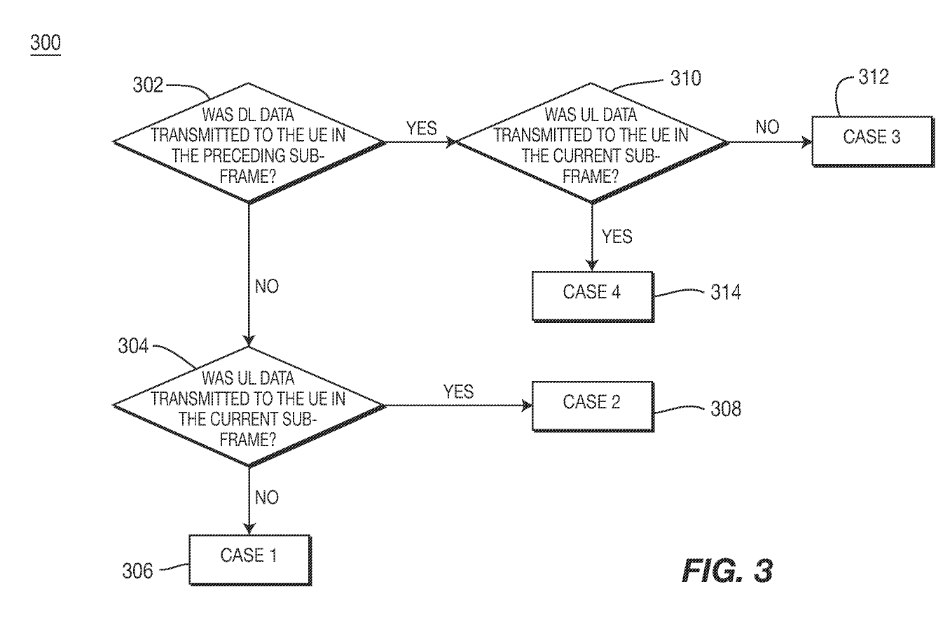

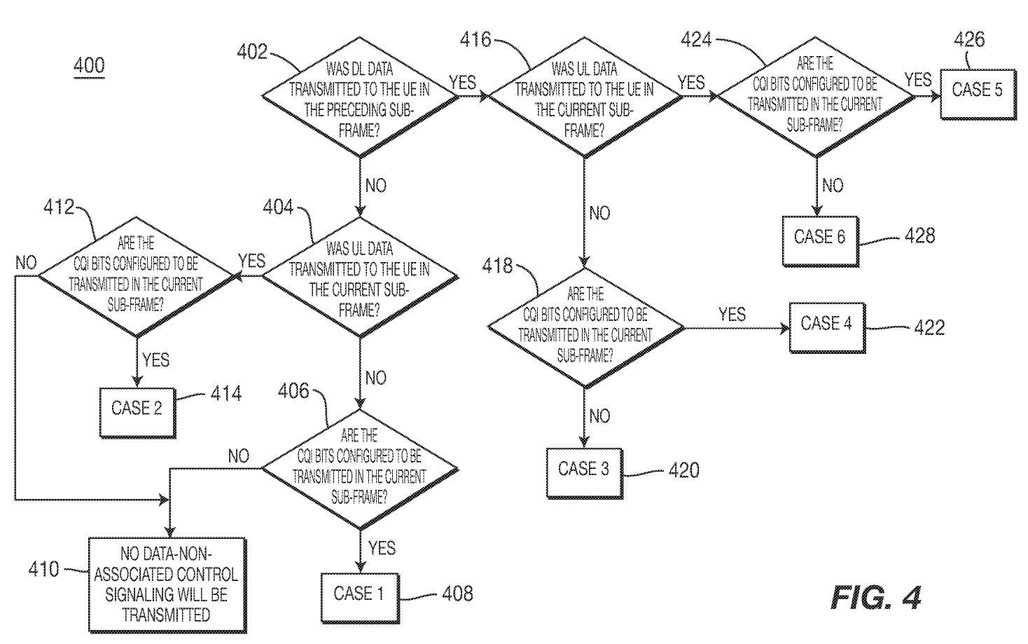

If there is data in the buffer at the Node B, then CQI reporting is scheduled every N sub-frames (step 104). As will be described in greater detail in connection with FIGS. 3 and 4, the value of N can be any value greater than or equal to one and no more than five or ten, depending on the implementation. The value of N relates to the mobility of the UE; the greater the mobility of the UE, the lower that the value of N should be. The Node B schedules the CQI reporting and the UL CQICH before the first downlink (DL) data transmission for the UE. The UL CQICH is configured to be transmitted once every N sub-frames.

The UL CQICH location (in terms of time and frequency) should be known for the Node B and the UE. A predefined time and frequency hopping pattern can be applied to the scheduled UL CQICH location (step 106). One example way of knowing the UL CQICH location is that Node B signals the UL CQICH location explicitly to the UE when the Node B schedules the CQI reporting. A pre-defined time and frequency hopping pattern can be applied to the scheduled UL CQICH location to achieve better time and frequency diversity. Since both the Node B and the UE know the UL CQICH location, the UE ID does not need to be transmitted on the UL CQICH.

There are several possible ways that the CQI bits of the UE can be multiplexed with the ACK/NACK information and/or the UL data-associated control information and user data of the same UE, and/or UL control information and user data of other UEs within one or more resource blocks.

The receiver (i.e., the Node B) needs UL pilots to decode the UL CQICH. Therefore, the UL pilots used for the UL CQICH need to be allocated with the UL CQICH as well. If frequency division multiplexing (FDM)-based UL pilots are used, then UL pilot locations (in the frequency domain) should be allocated. If code division multiplexing (CDM)-based UL pilots are used, then the UL pilot cyclic shift and frequency domain locations (optional) should be allocated. One example of a CDM-based pilot is the Constant Amplitude Zero Auto Correlation (CAZAC) sequence-based pilot. The information on the UL pilots used for the UL CQICH is signaled explicitly together with the UL CQICH. Alternatively, a pre-defined mapping is used between the UL CQICH locations (in the time and frequency domains) within one or more resource blocks and the UL pilots used for the UL CQICH. Therefore, there is no signaling overhead. The predefined mapping can be reconfigured through a broadcast signal or a control channel for more flexibility.

After the Node B receives the CQI feedback from the UE, it will start to schedule the DL data transmission on the DL shared data channel. The scheduling mode of DL data transmission for the UE can be changed dynamically. The possible scheduling modes include distributed, localized, MIMO (closed-loop and open-loop), and non-MIMO, and possible combinations of them. Different scheduling modes require different amounts of CQI feedback, such as the average CQI of the whole bandwidth, K best CQIs of chunks, CQIs to support closed-loop or open-loop MIMO, etc. Therefore, different UL CQICH types corresponding to different amounts of CQI feedback should be defined and allocated/scheduled accordingly.

The UL CQICH can be dynamically reconfigured during the packet call when the Node B switches between different scheduling modes. When reconfiguring the modes for localized, distributed, MIMO, etc., the configuration/reconfiguration, for example, can be set up using a broadcast channel. This is achievable when the common mode is used per cell or users use the same mode in a cell. However, when a hybrid scheme is used, i.e., each UE or connection has a different mode in a cell, then some shared control channel should be used to dynamically reconfigure the operation or scheduling modes. In this case, the information for the modes (1-3 bits) should be transmitted and carried in the shared control channel. The reconfiguration can be also done via RRC signaling in a slow fashion.

When hybrid modes are used such that some UEs have distributed modes, some UEs have localized modes, and some UEs have MIMO modes, the scheduling become more challenging. Scheduling algorithms therefore need to be used to efficiently cope with the “hybrid” scenario.

After the UL CQICH location is communicated to the UE, a determination is then made whether all of the data in the buffer at the Node B has been successfully transmitted to the UE (step 108). If all of the data has not been successfully transmitted, then step 108 is repeated until all of the data has been successfully transmitted. Once all of the data for the UE in the buffer at the Node B has been successfully transmitted, the Node B deallocates the UL CQICH (step 110), and the method 100 repeats by checking to see if there is any data in the buffer at the Node B (step 102).

Scheduling of the UL ACKCH

A shared channel is preferably used to transmit the ACK/NACK feedback for DL data transmission in UL SC-FDMA in a non-contention-based manner. A method 200 for scheduling the UL ACKCH is shown in FIG. 2. A determination is made whether there is a DL data transmission for the UE (step 202). If there is no DL transmission for the UE, then the method 200 waits at step 202 until there is DL data to be sent to the UE. When there is no DL data transmission for the UE, no UL ACKCH needs to be scheduled.

If there is DL data to be sent to the UE, then the UL ACKCH is scheduled M frames after the DL data is sent (step 204). A fixed timing (M sub-frames) is required between each DL data transmission scheduled by the Node B and the corresponding ACK/NACK feedback. In a preferred embodiment, M=1.

The UL ACKCH location is obtained (step 206), a signal is sent to the UE with the location of the UL ACKCH (step 208), and the method terminates (step 210). The UL ACKCH location (in time and frequency domains) should be known for both the Node B and the UE. There are two ways to obtain the UL ACKCH location. The first is by explicit signaling, in which case once the UL ACKCH location is obtained it is directly sent by the Node B to the UE for each scheduled DL data transmission (i.e., step 208 immediately follows step 206).

The second way to obtain the UL ACKCH location is by mapping the resource blocks used by the DL data transmission to the UL ACKCH location (step 212). The mapping should be transmitted to the UE via a broadcast channel (BCH). Optionally, a pre-defined time and frequency hopping pattern is applied to the mapping (step 214; shown in dashed outline). In this way, better time and frequency diversity is achieved for the UL ACKCH.

If K (for all K greater than one) resource blocks are used by the DL data transmission, there are two possible mappings of the UL ACKCH location:

1. The UL ACKCH uses the location mapped by the k^{th} (1≦k≦K) resource block used by the DL data transmission.

2. The UL ACKCH uses a permutation of the locations mapped by K resource blocks. For example, three resource blocks are used for DL data transmission. For the first transmission, the ACK/NACK is transmitted on the location mapped by the second resource block. For the second (re)transmission, the ACK/NACK is transmitted on the location mapped by the third resource block. For the third (re)transmission, the ACK/NACK is transmitted on location mapped by the first resource block, and so on.

Since both the Node B and the UE know the UL ACKCH location, then the UE ID does not need to be transmitted on the UL ACKCH.

There are several possible ways that the ACK/NACK information of a UE can be multiplexed with CQI bits and/or UL data-associated control information and user data of the same UE, and/or UL control information and user data of other UEs within one or more resource blocks. A receiver (i.e., the Node B) needs UL pilots to decode the UL ACKCH. Therefore, the UL pilots used for the UL ACKCH need to be allocated with the UL ACKCH as well. If FDM-based UL pilots are used, then the UL pilot locations (in the frequency domain) should be allocated. If CDM-based UL pilots (such as CAZAC-based pilots) are used, then the UL pilot cyclic shift and frequency domain locations (optional) should be allocated.

In a preferred embodiment, a pre-defined mapping between the UL ACKCH location (in the time and frequency domains) within one resource block is used and UL pilots are used for the UL ACKCH. Therefore, there is no signaling overhead.

Multiplexing of UL Data-Non-Associated Control Information

The UL CQICH is preferably configured to be transmitted once every N sub-frames, as described above. Depending on whether the value of N is larger than one, a different multiplexing of the UL data-independent control information can be used.

Multiplexing when the CQI is Configured to Send Feedback every Sub-frame

FIG. 3 shows a method 300 for multiplexing when the CQI reporting period, N, equals one sub-frame. A determination is made whether the was any DL data transmitted to the UE in the preceding sub-frame (step 302). If no DL data was transmitted to the UE in the preceding sub-frame, then a determination is made whether UL data was transmitted to the UE in the current sub-frame (step 304).

If no UL data was transmitted to the UE in the current sub-frame, then multiplexing Case 1 applies (step 306). In Case 1, the CQI bits are transmitted on the pre-defined UL CQICH. The pre-defined UL CQICH can be located at any resource block configured by the Node B, even multiplexed within the resource blocks used for other UE's UL data transmission.

If there was UL data that was transmitted to the UE in the current sub-frame (step 304), then Case 2 applies (step 308). In Case 2, there are two mutually exclusive choices for multiplexing. In Choice 2A, the CQI bits are transmitted on the pre-defined UL CQICH. For this choice, no resources are wasted; however, Choice 2A has more pilot overhead compared to Choice 2B.

In Choice 2B, the CQI bits are transmitted within the resource blocks scheduled for UL shared data transmission of the same UE. In this way, the CQI bits are multiplexed with the UL data-associated control bits and user data of the same UE. Choice 2B has no pilot overhead, as compared to Choice 2A; however, the UL data rate of the UE will be reduced. Since the UL shared data transmission is not always present, the pre-defined UL CQICH still needs to be allocated. The resources of the pre-defined UL CQICH will be wasted unless the Node B allocates other UEs to transmit on those resources, which makes the Node B scheduling complicated. It is optional that the Node B allocates the resources of the pre-defined UL CQICH for other UEs to transmit.

If there was DL data that was transmitted to the UE in the preceding sub-frame (step 302), then a determination is made whether UL data was transmitted to the UE in the current sub-frame (step 310). If no UL data was transmitted to the UE in the current sub-frame, then Case 3 applies (step 312). In Case 3, there are three mutually exclusive choices.

In Choice 3A, the ACK/NACK for DL data transmission is transmitted together with the CQI bits on the pre-defined UL CQICH. This choice saves pilot overhead compared to Choice 3C. Since the UL CQICH is always available, there is no need to allocate the UL ACKCH separately. However, the pre-defined UL CQICH has to be configured large enough to transmit the ACK/NACK information. Resources will be wasted when the ACK/NACK is not transmitted.

In Choice 3B, the CQI information is transmitted together with the ACK/NACK on the UL ACKCH. The UL ACKCH can be located at any resource block configured by the Node B, even multiplexed within the resource blocks used for other UE's UL data transmission. Choice 3B saves pilot overhead compared to Choice 3C. If the DL shared control channel (DL-SCCH) is not decoded correctly, the ACK/NACK will not be transmitted (because the UE does not know that there was a DL data transmission is the preceding sub-frame). In this case, the Node B thinks that the CQI bits were transmitted with the ACK/NACK on the pre-defined UL ACKCH. However, the ACK/NACK was not transmitted, which will create a problem. However, since the ACKCH is not always available, the pre-defined UL CQICH still needs to be allocated. The resources of the pre-defined UL CQICH will be wasted unless the Node B allocates other UEs to transmit on those resources, which makes the Node B scheduling complicated. It is optional that the Node B allocates the resources of a pre-defined UL CQICH for other UEs to transmit.

In Choice 3C, the ACK/NACK and the CQI are transmitted separately. That is, the ACK/NACK is transmitted on the UL ACKCH, and the CQI bits are transmitted on the pre-defined UL CQICH. For Choice 3C, no resources are wasted on the UL CQICH; however, there is more pilot overhead as compared to Choices 3A and 3B.

If there was UL data transmitted to the UE in the current sub-frame (step 310), then Case 4 applies (step 314). In Case 4, there are four mutually exclusive choices for multiplexing. In Choice 4C, the ACK/NACK and the CQI bits are transmitted together within the resource blocks scheduled for UL shared data transmission of the same UE. In this way, the ACK/NACK and the CQI bits are multiplexed with the UL data-associated control bits and user data of the same UE. Choice 4A has no pilot overhead; however, the UL data rate of the UE will be reduced. Since the UL shared data transmission is not always present, the pre-defined UL CQICH (and maybe the UL ACKCH as well) still needs to be allocated. The resources of the pre-defined UL CQICH (and UL ACKCH, if any) will be wasted unless the Node B allocates other UEs to transmit on those resources, which makes the Node B scheduling complicated. It is optional that the Node B allocates the resources of the pre-defined UL CQICH (and UL ACKCH, if any) for other UEs to transmit.

In Choice 4B, the ACK/NACK for DL data transmission is transmitted together with the CQI bits on the pre-defined UL CQICH. Choice 4B has less pilot overhead compared to Choice 4D, but has more pilot overhead compared to Choice 4A. Since the UL CQICH is always available, there is no need to allocate the UL ACKCH, and the UL data rate of the UE will not be reduced. However, the pre-defined UL CQICH has to be configured large enough to transmit the ACK/NACK information. Resources will be wasted when the ACK/NACK is not transmitted.

In Choice 4C, the CQI information is transmitted together with the ACK/NACK information on the pre-defined UL ACKCH. Choice 4C has less overhead compared to Choice 4D, but has more pilot overhead compared to Choice 4A. The UL data rate of the UE will not be reduced. Other disadvantages to Choice 4C are the same as the disadvantages of Choice 3B of Case 3.

In Choice 4D, the ACK/NACK and the CQI are transmitted separately. That is, the ACK/NACK is transmitted on the pre-defined UL ACKCH, and the CQI bits are transmitted on the pre-defined UL CQICH. For Choice 4D, no resources are wasted in the UL CQICH and the UL ACKCH. The UL data rate of the UE will not be reduced. However, Choice 4D has more pilot overhead compared to Choices 4C, 4B, and 4C.

Moreover, the UL resources request (called “scheduling information”) bits can be transmitted on the UL CQICH or the UL ACKCH of the same UE, or can be transmitted together within the resource blocks scheduled for UL shared data transmission of the same UE. Correspondingly, the UL CQICH or the UL ACKCH needs to be configured large enough to accommodate the UL resource request bits. Or the number of UL resource request bits need to be reserved in the resource blocks scheduled for UL shared data transmission of the same UE.

Multiplexing when the CQI Reporting is Less Frequent than every Sub-frame

FIG. 4 shows a method 400 for multiplexing when the CQI reporting period, N, is larger than one sub-frame. A determination is made whether the was any DL data transmitted to the UE in the preceding sub-frame (step 402). If no DL data was transmitted to the UE in the preceding sub-frame, then a determination is made whether UL data was transmitted to the UE in the current sub-frame (step 404). If no UL data was transmitted to the UE in the current sub-frame, then a determination is made whether the CQI bits are configured to be transmitted in the current sub-frame (step 406). If the CQI bits are configured to be transmitted in the current sub-frame, then Case 1 applies (step 408). In Case 1, the CQI bits are transmitted on the pre-defined UL CQICH. If the CQI bits are not configured to be transmitted in the current sub-frame (step 406), then no data-non-associated control signaling will be transmitted (step 410).

If there was UL data transmitted to the UE in the current sub-frame (step 404), then a determination is made whether the CQI bits are configured to be transmitted in the current sub-frame (step 412). If the CQI bits are configured to be transmitted in the current sub-frame, then Case 2 applies (step 414). In Case 2, there are two mutually exclusive choices for multiplexing. In Choice 2A, the CQI bits are transmitted on the pre-defined UL CQICH. Choice 4A has no resources wasted on the UL CQICH; however, it needs more pilot overhead compared to Choice 2B.

In Choice 2B, the CQI bits are transmitted within the resource blocks scheduled for UL shared data transmission of the same UE. In this way, the CQI bits are multiplexed with the UL data-associated control bits and user data of the same UE. It has less pilot overhead compared to Choice 2C. However, the UL data rate of the UE will be reduced. Since UL shared data transmission is not always present, the pre-defined UL CQICH still needs to be allocated. The resources of the pre-defined UL CQICH will be wasted unless the Node B allocates other UEs to transmit on those resources, which makes the Node B scheduling complicated. It is optional that the Node B allocates the resources of the pre-defined UL CQICH for other UEs to transmit.

If the CQI bits are not configured to be transmitted in the current sub-frame (step 412), then no data-non-associated control signaling will be transmitted (step 410).

If there was DL data transmitted to the UE in the preceding sub-frame (step 402), then a determination is made whether UL data was transmitted to the UE in the current sub-frame (step 416). If no UL data was transmitted to the UE in the current sub-frame, then a determination is made whether the CQI bits are configured to be transmitted in the current sub-frame (step 418). If the CQI bits are not configured to be transmitted in the current sub-frame, then Case 3 applies (step 420). In Case 3, the ACK/NACK for the DL data transmission should be transmitted on the UL ACKCH.

If the CQI bits are configured to be transmitted in the current sub-frame (step 418), then Case 4 applies (step 422). In Case 4, there are three mutually exclusive choices for multiplexing. In Choice 4A, the ACK/NACK for DL data transmission is transmitted together with the CQI bits on the pre-defined UL CQICH. Choice 4A has a low pilot overhead. However, the pre-defined UL CQICH has to be configured large enough to transmit the ACK/NACK information. Resources will be wasted when the ACK/NACK is not transmitted. Since the UL CQICH is not always available when the ACK/NACK needs to be transmitted, the pre-defined UL ACKCH still needs to be allocated. The resources of the pre-defined UL ACKCH will be wasted unless the Node B allocates other UEs to transmit on those resources, which makes the Node B scheduling complicated. It is optional that the Node B allocates the resources of the pre-defined UL CQICH (and UL ACKCH, if any) for other UEs to transmit.

In Choice 4B, the CQI information is transmitted together with the ACK/NACK on the pre-defined UL ACKCH. Choice 4B has a low pilot overhead. If the DL-SCCH is not decoded correctly, the ACK/NACK will not be transmitted (because the UE does not know that there was a DL data transmission is the preceding sub-frame). In this case, the Node B thinks that the CQI bits were transmitted with the ACK/NACK on the pre-defined UL ACKCH. However, the ACK/NACK is not transmitted, which will create a problem. Since the ACKCH is not always available, the pre-defined UL CQICH still needs to be allocated. The resources of the pre-defined UL CQICH will be wasted unless the Node B allocates other UEs to transmit on those resources, which makes the Node B scheduling complicated. It is optional that the Node B allocates the resources of the pre-defined UL CQICH for other UEs to transmit.

In Choice 4C, the ACK/NACK and the CQI are transmitted separately. That is, the ACK/NACK is transmitted on the UL ACKCH, and the CQI bits are transmitted on the pre-defined UL CQICH. Choice 3C has no resources wasted on the UL CQICH or the UL ACKCH; however, it has more pilot overhead compared to Choices 4A and 4B.

If there was UL data transmitted to the UE in the current sub-frame (step 416), then a determination is made whether the CQI bits are configured to be transmitted in the current sub-frame (step 424). If the CQI bits are configured to be transmitted in the current sub-frame, then Case 5 applies (step 426). In Case 5, there are four mutually exclusive choices for multiplexing.

In Choice 5A, the ACK/NACK and the CQI bits are transmitted together within the resource blocks scheduled for UL shared data transmission of the same UE. In this way, the ACK/NACK and the CQI bits are multiplexed with UL data-associated control bits and user data of the same UE. Choice 5A has less pilot overhead compared to Choices 5B, 5C, and 5D. However, the UL data rate of the UE will be reduced. Since UL shared data transmission is not always present, the pre-defined UL CQICH (and maybe the UL ACKCH as well) still needs to be allocated. The resources of the pre-defined UL CQICH (and ACKCH, if any) will be wasted unless the Node B allocates other UEs to transmit on those resources, which makes the Node B scheduling complicated. It is optional that the Node B allocates the resources of the pre-defined UL CQICH (and UL ACKCH, if any) for other UEs to transmit.

In Choice 5B, the ACK/NACK for DL data transmission is transmitted together with the CQI bits on the pre-defined UL CQICH. Choice 5B has less pilot overhead compared to Choice 5D. The UL data rate of the UE will not be reduced. However, the pre-defined UL CQICH has to be configured large enough to transmit the ACK/NACK information. Resources will be wasted when the ACK/NACK is not transmitted on the UL CQICH. Since the UL CQICH is not always available when the ACK/NACK needs to transmitted, the UL ACKCH still needs to be allocated. The resources of the pre-defined UL ACKCH will be wasted unless the Node B allocates other UEs to transmit on those resources, which makes the Node B scheduling complicated. It is optional that the Node B allocates the resources of the pre-defined UL ACKCH for other UEs to transmit.

In Choice 5C, the CQI information is transmitted together with the ACK/NACK on the UL ACKCH. Choice 5C saves pilot overhead compared to Choice 5D. The UL data rate of the UE will not be reduced. However, Choice 5C has more pilot overhead compared to Choice 5A. Other disadvantages of Choice 5C are the same as the disadvantages of Choice 4B of Case 4.

In Choice 5D, the ACK/NACK and the CQI are transmitted separately. That is, the ACK/NACK is transmitted on the pre-defined UL ACKCH, and the CQI bits are transmitted on the pre-defined UL CQICH. For Choice 5D, no resources are wasted for the UL CQICH and the UL ACKCH. The UL data rate of the UE will not be reduced. However, Choice 5D has more pilot overhead compared to Choices 5A, 5B, and 5C.

If the CQI bits are not configured to be transmitted in the current sub-frame (step 424), then Case 6 applies (step 428). In Case 6, there are two mutually exclusive choices for multiplexing.

In Choice 6C, the ACK/NACK information is transmitted within the resource blocks scheduled for UL shared data transmission of the same UE. In this way, the ACK/NACK information is multiplexed with UL data-associated control bits and user data of the same UE. Choice 6C has no pilot overhead; however, the UL data rate of the UE will be reduced. Since UL shared data transmission is not always present, the UL ACKCH still needs to be allocated. The resources of the pre-defined UL ACKCH will be wasted unless the Node B allocates other UEs to transmit on those resources, which makes the Node B scheduling complicated. It is optional that the Node B allocates the resources of the pre-defined UL ACKCH for other UEs to transmit.

In Choice 6B, the ACK/NACK is transmitted on the UL ACKCH. For Choice 6B, the UL data rate of the UE will not be reduced. No resources are wasted for the UL ACKCH; however, Choice 6B has more pilot overhead as compared to Choice 6C.

Moreover, the UL resources request (called “scheduling information”) bits can be transmitted on the UL CQICH or the UL ACKCH of the same UE, or transmitted together within the resource blocks scheduled for UL shared data transmission of the same UE. Correspondingly, the UL CQICH or the UL ACKCH needs to be configured large enough to accommodate UL resource request bits. Or, the number of UL resource request bits need to be reserved in the resource blocks scheduled for UL shared data transmission of the same UE.

System Construction

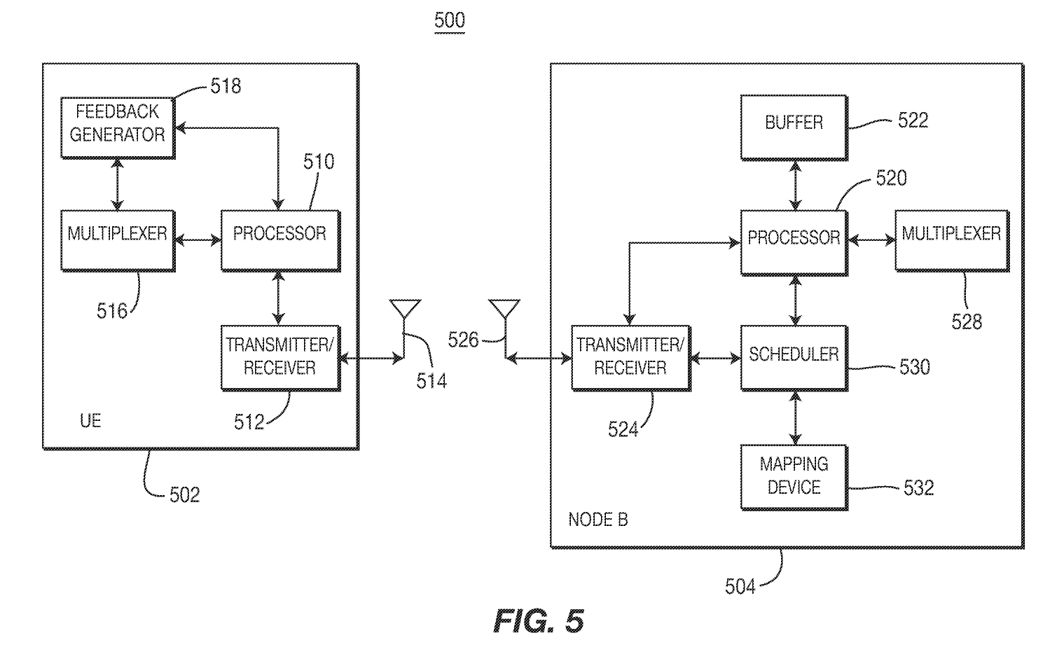

FIG. 5 is a block diagram of a system 500 for scheduling and multiplexing CQI reporting and ACK/NACK reporting, including a UE 502 and a Node B 504. The UE 502 includes a processor 510, a transmitter/receiver 512 in communication with the processor 510, and an antenna 514 connected to the transmitter/receiver 512. A multiplexer 516 is in communication with the processor 510. A feedback generator 518 is in communication with the processor 510 and the multiplexer 516. The feedback generator 518 can provide a CQI and an ACK/NACK for received DL data.

The Node B 504 includes a processor 520 and a buffer 522 in communication with the processor 520. The buffer 522 holds data to be sent to the UE 502. A transmitter/receiver 524 is in communication with the processor 520 and an antenna 526 is connected to the transmitter/receiver 524. A multiplexer 528 is in communication with the processor 520. A scheduler 530 is in communication with the processor 520 and the transmitter/receiver 524. The scheduler 530 is used to schedule CQI reporting and ACK/NACK reporting to the UE 502. A mapping device 532 is in communication with the scheduler 530, and is used to map resource blocks used by a DL data transmission to an UL channel location.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any integrated circuit, and/or a state machine.

A processor in association with software may be used to implement a radio frequency transceiver for in use in a wireless transmit receive unit (WTRU), user equipment, terminal, base station, radio network controller, or any host computer. The WTRU may be used in conjunction with modules, implemented in hardware and/or software, such as a camera, a video camera module, a videophone, a speakerphone, a vibration device, a speaker, a microphone, a television transceiver, a hands-free headset, a keyboard, a Bluetooth module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for transmitting channel quality indicator (CQI) feedback by a user equipment (UE) in a wireless communication system, comprising the steps of:
scheduling a non-contention based uplink channel; and
transmitting the CQI on the scheduled uplink channel.

2. The method according to claim 1, wherein the scheduling step includes:
scheduling periodic CQI reporting;
determining a location of the uplink channel to use for reporting the CQI; and
signaling the location of the uplink channel and the CQI reporting period to the UE.

3. The method according to claim 1, further comprising the step of:
deallocating the uplink channel.

4. The method according to claim 3, wherein the deallocating step includes:
examining a buffer at a Node B that holds data to be sent to the UE; and
deallocating the uplink channel when the buffer at the Node B is empty.

5. The method according to claim 1, wherein the transmitting step includes:
multiplexing the CQI with at least one item selected from the group consisting of: acknowledgement/negative acknowledgement information, uplink data-associated control information of the UE, user data of the UE, uplink control information of another UE, and user data of another UE.

6. The method according to claim 1, further comprising the step of:
scheduling a downlink data transmission from a Node B to the UE, wherein a scheduling mode for the downlink data transmission is based on the CQI feedback transmitted by the UE.

7. The method according to claim 6, further comprising the step of:
dynamically reconfiguring the uplink channel based on the scheduling mode used by the Node B for the downlink data transmission.

8. A method for transmitting acknowledgement (ACK)/negative acknowledgement (NACK) feedback by a user equipment (UE) in a wireless communication system, comprising the steps of:
scheduling a non-contention based uplink channel; and
transmitting the ACK/NACK on the scheduled uplink channel.

9. The method according to claim 8, wherein the scheduling step includes:
scheduling periodic ACK/NACK reporting;
determining a location of the uplink channel to use for reporting the ACK/NACK; and
signaling the location of the uplink channel and the ACK/NACK reporting period to the UE.

10. The method according to claim 9, wherein the determining step includes:
explicitly signaling the location of the uplink channel from a Node B to the UE.

11. The method according to claim 9, wherein the determining step includes:
mapping resource blocks used by a downlink data transmission to the uplink channel location.

12. The method according to claim 11, wherein the mapping step includes:
using a location mapped by a predetermined resource block used by the downlink data transmission.

13. The method according to claim 11, wherein the mapping step includes:
using a permutation of the location mapped by a number of resource blocks.

14. The method according to claim 8, wherein the transmitting step includes:
multiplexing the ACK/NACK with at least one item selected from the group consisting of: channel quality indicator information, uplink data-associated control information of the UE, user data of the UE, uplink control information of another UE, and user data of another UE.

15. A method for multiplexing feedback information when a channel quality indicator (CQI) is configured to be sent every sub-frame, comprising the steps of:
determining whether downlink data was transmitted to a user equipment (UE) in the preceding sub-frame;
determining whether uplink data was transmitted to the UE in the current sub-frame; and
transmitting the CQI on a predetermined uplink channel if there was no downlink data transmitted to the UE in the preceding sub-frame.

16. A method for multiplexing feedback information when a channel quality indicator (CQI) is configured to be sent every sub-frame, comprising the steps of:
determining whether downlink data was transmitted to a user equipment (UE) in the preceding sub-frame;
determining whether uplink data was transmitted to the UE in the current sub-frame; and
transmitting the CQI within resource blocks scheduled for uplink shared data transmission of the UE if
there was no downlink data transmitted to the UE in the preceding sub-frame; and
there was uplink data was transmitted to the UE in the current sub-frame.

17. A method for multiplexing feedback information when a channel quality indicator (CQI) is configured to be sent every sub-frame, comprising the steps of:
determining whether downlink data was transmitted to a user equipment (UE) in the preceding sub-frame;
determining whether uplink data was transmitted to the UE in the current sub-frame; and
transmitting the CQI with an acknowledgement/negative acknowledgement for downlink data on a predetermined uplink channel if
there was downlink data transmitted to the UE in the preceding sub-frame; and
there was no uplink data was transmitted to the UE in the current sub-frame.

18. The method according to claim 17, wherein the uplink channel is used for CQI transmission.

19. The method according to claim 17, wherein the uplink channel is used for acknowledgement/negative acknowledgement transmission.

20. A method for multiplexing feedback information when a channel quality indicator (CQI) is configured to be sent every sub-frame, comprising the steps of:
determining whether downlink data was transmitted to a user equipment (UE) in the preceding sub-frame;
determining whether uplink data was transmitted to the UE in the current sub-frame; and
transmitting the CQI on a predetermined uplink channel for CQI transmission and transmitting an acknowledgement/negative acknowledgement (ACK/NACK) for downlink data on a predetermined uplink channel for ACK/NACK transmission.

21. A method for multiplexing feedback information when a channel quality indicator (CQI) is configured to be sent every sub-frame, comprising the steps of:
determining whether downlink data was transmitted to a user equipment (UE) in the preceding sub-frame;
determining whether uplink data was transmitted to the UE in the current sub-frame; and
transmitting the CQI with an acknowledgement/negative acknowledgement for downlink data within resource blocks scheduled for uplink shared data transmission of the UE if
there was downlink data transmitted to the UE in the preceding sub-frame; and
there was uplink data was transmitted to the UE in the current sub-frame.

22. A method for multiplexing feedback information when a channel quality indicator (CQI) is configured to be sent every sub-frame, comprising the steps of:
determining whether downlink data was transmitted to a user equipment (UE) in the preceding sub-frame;
determining whether uplink data was transmitted to the UE in the current sub-frame; and
transmitting the CQI with an acknowledgement/negative acknowledgement for downlink data on a predetermined uplink channel for CQI transmission if
there was downlink data transmitted to the UE in the preceding sub-frame; and
there was uplink data was transmitted to the UE in the current sub-frame.

23. A method for multiplexing feedback information when a channel quality indicator (CQI) is configured to be sent every sub-frame, comprising the steps of:
determining whether downlink data was transmitted to a user equipment (UE) in the preceding sub-frame;
determining whether uplink data was transmitted to the UE in the current sub-frame; and
transmitting the CQI with an acknowledgement/negative acknowledgement (ACK/NACK) for downlink data on a predetermined uplink channel for ACK/NACK transmission if
there was downlink data transmitted to the UE in the preceding sub-frame; and
there was uplink data was transmitted to the UE in the current sub-frame.

24. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI bits on a predetermined uplink channel if
there was no downlink data transmitted to the UE in the preceding sub-frame;
there was no uplink data was transmitted to the UE in the current sub-frame; and
the CQI bits were not configured to be transmitted in the current sub-frame.

25. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI bits on a predetermined uplink channel if
there was no downlink data transmitted to the UE in the preceding sub-frame;
there was uplink data was transmitted to the UE in the current sub-frame; and
the CQI bits were configured to be transmitted in the current sub-frame.

26. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI within resource blocks scheduled for uplink shared data transmission of the UE if
there was no downlink data transmitted to the UE in the preceding sub-frame;
there was uplink data was transmitted to the UE in the current sub-frame; and
the CQI bits were configured to be transmitted in the current sub-frame.

27. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting an acknowledgement/negative acknowledgement for downlink data transmitted on a predetermined uplink channel if
there was downlink data transmitted to the UE in the preceding sub-frame;
there was no uplink data was transmitted to the UE in the current sub-frame; and
the CQI bits were not configured to be transmitted in the current sub-frame.

28. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI with an acknowledgement/negative acknowledgement for downlink data on a predetermined uplink channel if
there was downlink data transmitted to the UE in the preceding sub-frame;
there was no uplink data was transmitted to the UE in the current sub-frame; and
the CQI bits were configured to be transmitted in the current sub-frame.

29. The method according to claim 28, wherein the uplink channel is used for CQI transmission.

30. The method according to claim 28, wherein the uplink channel is used for acknowledgement/negative acknowledgement transmission.

31. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI on a predetermined uplink channel for CQI transmission and transmitting an acknowledgement/negative acknowledgement (ACK/NACK) for downlink data on a predetermined uplink channel for ACK/NACK transmission if
there was downlink data transmitted to the UE in the preceding sub-frame;
there was no uplink data was transmitted to the UE in the current sub-frame; and
the CQI bits were configured to be transmitted in the current sub-frame.

32. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI with an acknowledgement/negative acknowledgement for downlink data within resource blocks scheduled for uplink shared data transmission of the UE if
there was downlink data transmitted to the UE in the preceding sub-frame;
there was uplink data was transmitted to the UE in the current sub-frame; and
the CQI bits were configured to be transmitted in the current sub-frame.

33. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI with an acknowledgement/negative acknowledgement for downlink data on a predetermined uplink channel if
there was downlink data transmitted to the UE in the preceding sub-frame;
there was uplink data was transmitted to the UE in the current sub-frame; and
the CQI bits were configured to be transmitted in the current sub-frame.

34. The method according to claim 33, wherein the uplink channel is used for CQI transmission.

35. The method according to claim 33, wherein the uplink channel is used for acknowledgement/negative acknowledgement transmission.

36. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting the CQI on a predetermined uplink channel for CQI transmission and transmitting an acknowledgement/negative acknowledgement (ACK/NACK) for downlink data on a predetermined uplink channel for ACK/NACK transmission if
there was downlink data transmitted to the UE in the preceding sub-frame;
there was uplink data was transmitted to the UE in the current sub-frame; and
the CQI bits were configured to be transmitted in the current sub-frame.

37. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting an acknowledgement/negative acknowledgement within resource blocks scheduled for uplink shared data transmission of the UE if
there was downlink data transmitted to the UE in the preceding sub-frame;
there was uplink data was transmitted to the UE in the current sub-frame; and
the CQI bits were not configured to be transmitted in the current sub-frame.

38. A method for multiplexing feedback information when a channel quality indicator (CQI) is configured to be sent at an interval less frequent than every sub-frame, comprising the steps of:
determining whether downlink data was transmitted to a user equipment (UE) in the preceding sub-frame;
determining whether uplink data was transmitted to the UE in the current sub-frame;
determining whether the CQI bits are configured to be transmitted in the current sub-frame; and
transmitting an acknowledgement/negative acknowledgement on a predetermined uplink channel if
there was downlink data transmitted to the UE in the preceding sub-frame;
there was uplink data was transmitted to the UE in the current sub-frame; and
the CQI bits were not configured to be transmitted in the current sub-frame.

39. A system for scheduling and multiplexing feedback reporting in a wireless communication system, comprising:
a user equipment, comprising:
a first processor;
a first transmitter/receiver in communication with said first processor;
a first antenna connected to said first transmitter/receiver;
a feedback generator in communication with said first processor and said first multiplexer, said feedback generator for generating feedback based on received downlink data; and
a first multiplexer in communication with said first processor, said first multiplexer for multiplexing feedback information from said feedback generator with other uplink data; and
a Node B, comprising:
a second processor;
a buffer in communication with said second processor, said buffer storing data to be sent to said user equipment;
a second transmitter/receiver in communication with said second processor;
a second antenna connected to said second transmitter/receiver;
a second multiplexer in communication with said second processor;
a scheduler in communication with said second processor and said second transmitter/receiver, said scheduler for scheduling an uplink feedback channel; and
a mapping device in communication with said scheduler, said mapping device for mapping resource blocks from a downlink communication to an uplink feedback channel location.
